(19) United States
(12) Patent Application Publication
(10) Pub. No.: US 2012/0173984 A1
(43) Pub. Date: Jul. 5, 2012

(54) CONTEXT-ADDRESSED TABS FOR PRESENTATION APPLICATIONS

(75) Inventors: Lisa Seacat DeLuca, San Francisco, CA (US); Robert Ross Peterson, Austin, TX (US)

(73) Assignee: INTERNATIONAL BUSINESS MACHINES CORPORATION, ARMONK, NY (US)

(21) Appl. No.: 12/981,964

(22) Filed: Dec. 30, 2010

(51) Int. Cl. G06F 3/048

(52) U.S. Cl. 715/730

(57) ABSTRACT

A method, system and computer program product for providing and using context-addressed tabs in a computer presentation application may include selecting at least one element in a current slide of a presentation displayable in a computer window. The method, system and computer program product may also include generating a context-addressed tab in a predetermined area of the computer window for each selected element in the current slide of the presentation. Each context-addressed tab may be addressed to an associated selected element in the current slide of the presentation.

### BACKGROUND

Aspects of the present invention relate to presentation applications or software programs operable on a computer system, and more particularly to a method, system and computer program product for context-addressed tabs for computer presentation applications.

Computer applications or software for use in creating and making presentations are used extensively. Such presentation applications typically present or display a slide show using a computer device and some sort of display device or screen of the computer device. Perhaps one of the most widely used presentation applications is Microsoft Powerpoint. Microsoft and Powerpoint are trademarks of the Microsoft Corporation in the United States, other countries or both. Microsoft Powerpoint includes a feature to permit a user to enter comments in a box at the bottom of each slide or annotations to a particular object. However, there is no feature or mechanism to allow a user to select elements or objects in a slide, such as text, images or other visible features and to further organize comments and efficiently differentiate or segregate comments or information for the different selected elements in complex or significant slides.

### BRIEF SUMMARY

According to one aspect of the present invention, a method for providing and using context-addressed tabs in a computer presentation application may include selecting at least one element in a current slide of a presentation displayable in a computer window. The method may also include generating a context-addressed tab in a predetermined area of the computer window for each selected element in the current slide of the presentation. Each context-addressed tab may be addressed to an associated selected element in the current slide of the presentation.

According to another aspect of the present invention, a system for providing and using context-addressed tabs in a computer presentation application may include a processor. The system may also include a module operating on the processor for providing and using context-addressed tabs in a computer presentation application. The module may include a module for selecting at least one element in a current slide of a presentation displayable in a computer window. The module may also include another module for generating a context-addressed tab in a predetermined area of the computer window for each selected element in the current slide of the presentation. Each context-addressed tab being addressed to an associated selected element in the current slide of the presentation.

According to a further aspect of the present invention, a computer program product for providing and using context-addressed tabs in a computer presentation application may include a computer readable storage medium having computer readable program code embodied therewith. The computer readable program code may include computer readable program code configured to select at least one element in a current slide of a presentation displayable in a computer window. The computer readable program code may also include computer readable program code configured to generate a context-addressed tab in a predetermined area of the computer window for each selected element in the current slide of the presentation. Each context-addressed tab being addressed to an associated selected element in the current slide of the presentation.

### BRIEF DESCRIPTION OF THE SEVERAL VIEWS OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 is a flowchart of an example of a method 100 for forming or generating context-addressed tabs in a computer presentation application in accordance with an embodiment of the present invention.

FIG. 2 is flowchart of an example of a method for using context-addressed tabs in a computer presentation application in accordance with an embodiment of the present invention.

FIG. 3 is an example of a slide in a presentation including context-addressed tabs in accordance with an embodiment of the present invention.

FIG. 4 is a block schematic diagram of an example of a system for providing context-addressed tabs in a computer presentation application in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

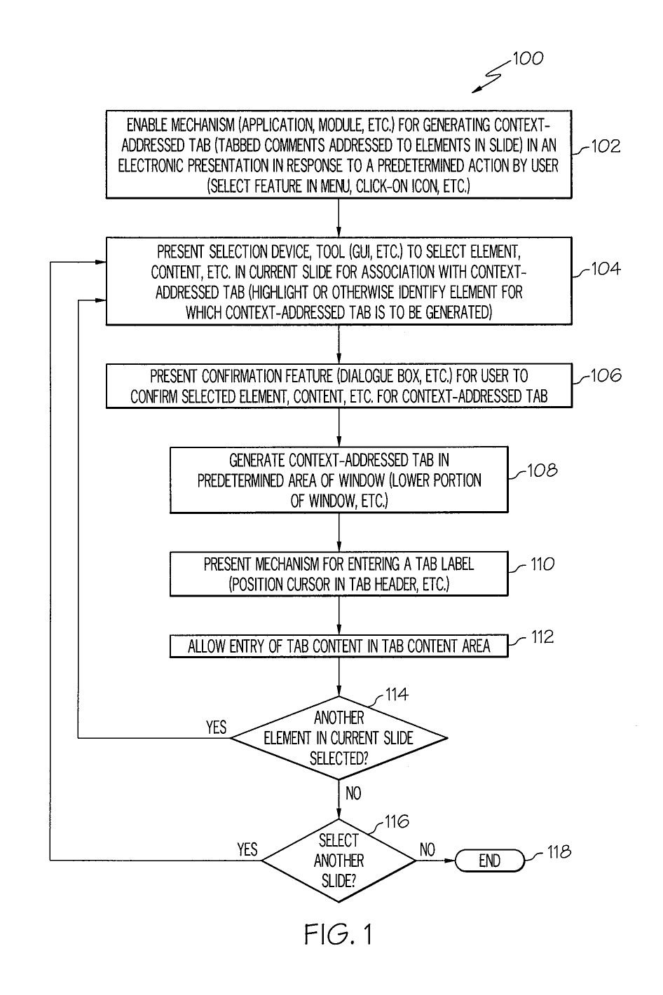

FIG. 1 is a flowchart of an example of a method 100 for providing context-addressed tabs in a computer presentation application in accordance with an embodiment of the present invention. In block 102, a mechanism for generating a context-addressed tab for association with a selected element in a slide of a computer presentation may be enabled. The mechanism may be an application or module that may be part of the presentation application or software program or may be a separate application or module operable in conjunction with the presentation application on a computer or computing device. The mechanism may be enabled in response to a predetermined action by a user. Examples of the predetermined action may include selecting a context-addressed tab feature in a menu using a computer pointing device, clicking-on an icon representing the context-addressed tab feature using a computer pointing device, or a similar mechanism for selecting a feature or activating a computer application as is known in the computing arts.

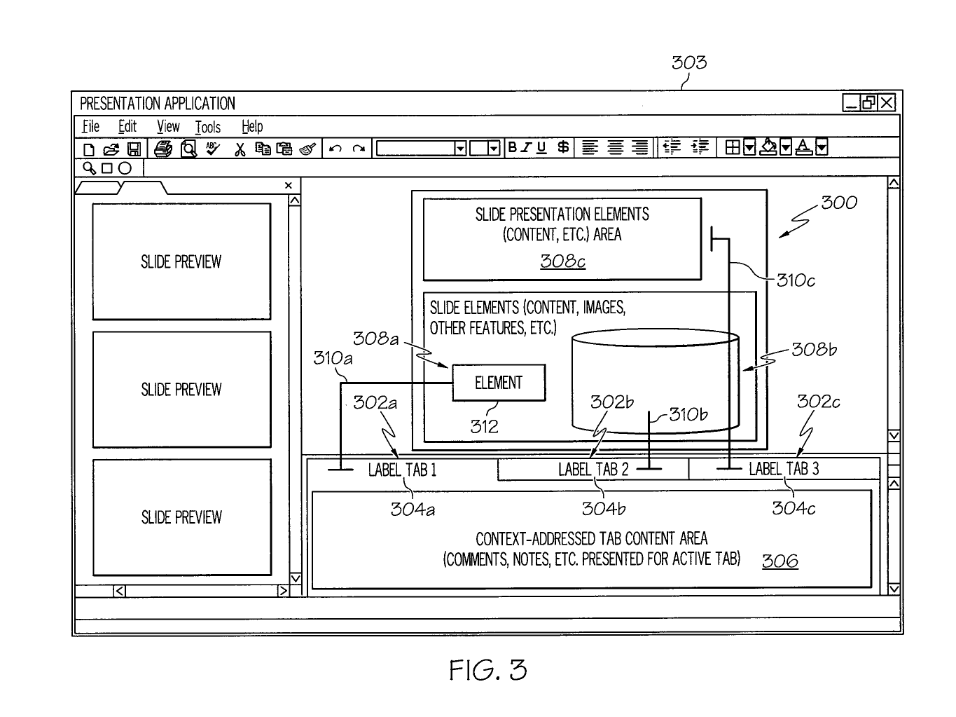

An example of context-addressed tabs in a computer presentation application will be described in more detail with reference to FIG. 3. Briefly, context-addressed tabs may include any content, such as comments, notes or other information that may be entered into a content area or portion of the tab. The context-addressed tab also includes an adjoining tab label portion or tab header. The tab label portion or header may be activated or clicked-on using a computer pointing device to present the content area or portion of an inactive context-addressed tab in a window of a computer display. The content area is visible in the computer window for the currently active tab. Only the tab label portion or header is visible in the computer window for the inactive context-addressed tabs. As described in more detail herein each context-addressed tab may be addressed to at least one selected element in a current slide of a presentation being displayed in the window of the computer display. The context-addressed tab being addressed to at least one selected element may also be described as the context-addressed tab being linked to, mapped to or associated with the at least one selected element in the slide.

In block 104, a selection device, tool or the like may be presented to select at least one element in a current slide of a presentation for which a context-addressed tab is to be generated and to which the context-addressed tab is to be associated, linked, mapped or addressed. Examples of the selection device or tool may include a graphical user interface, a snapshot selection tool similar to that provided in a Preferred Document Format (PDF) viewer for selecting elements in a PDF document, or any similar computer selection device or tool. The element that may be selected in the slide that is currently being presented in the computer window may include but is not necessarily limited to any content in the slide, such as text, images or other features in the presentation slide. The selected element in the slide may be highlighted or otherwise identified or designated visually to the user. For example, the selected element may be highlighted or otherwise identified by enclosing the selected element in a rectangle or box having a predetermined color. In another aspect of the invention, shadowing may be displayed over the selected element. Any means of visually indicating that the element has been selected may be used.

In block 106, a confirmation feature may be presented for the user to confirm the selected element for association with the context-addressed tab being created. The confirmation feature may include a dialogue box or any mechanism for indicating that the desired element in the presentation slide has been selected.

In block 108, the context-addressed tab may be generated in a predetermined area of the computer window. For an example, the area in the computer window for displaying the context-addressed tabs may be in a lower portion of the window similar to that in the example illustrated in FIG. 3.

In block 110, a mechanism for entering a tab label in a tab label portion or tab header may be presented. The mechanism may include positioning a cursor in the tab label portion for the user to type in or enter a label for the context-addressed tab being created. The label may refer to the associated selected element in the slide or content or information contained in the context-addressed tab or both.

In block 112, the user may enter content into a tab content portion or area. As previously described the tab content may include comments, notes or other information that may be related to the associated selected element in the slide.

In block 114, a determination may be made whether another element in the current slide has been selected by the user. If another element has been selected, the method 100 may return to block 104 and the method 100 may proceed as previously described. If another element is not selected in the current slide the method 100 may advance to block 116. In block 116, a determination may be made if another slide has been selected. If another slide has been selected, the method 100 may return to block 104 and the method 100 may proceed similar to that previously described. If another slide has not been selected in block 116, the method 100 may advance to block 118 and the method 100 may be terminated.

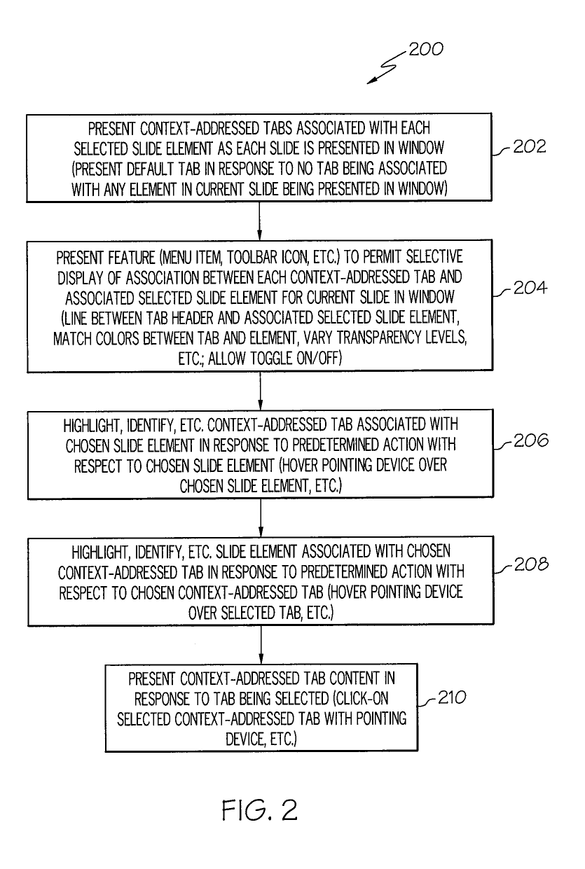

FIG. 2 is flowchart of an example of a method 200 for using context-addressed tabs in a computer presentation in accordance with an embodiment of the present invention. While the blocks illustrated in FIG. 2 are in a flowchart format, the operations and functions described are not necessarily in any particular order and the invention is not intended to be limited by the order of the blocks and the associated, exemplary operations and functions illustrated and described.

In block 202, the context-addressed tabs associated with each selected slide element may be presented as each slide is presented in the computer window. Accordingly, as a user progresses through the different slides of the presentation, the context-addressed tabs may be presented if the user has the context-addressed tab feature active or enabled. The user may also present or display the content associated with each context-addressed tab for a particular slide by activating the tab. The tab may be activated by clicking-on the tab label portion or header portion of the tab which is visible in the computer window using a computer pointing device or by any other method of activating the tab. A default tab may be presented in response to no context-addressed tabs being associated with any elements in a current slide being presented in the computer window.

In block 204, a feature may be presented to permit selective display of an association or link between each context-addressed tab and the element in the currently displayed slide to which the context-addressed tab is associated, linked, mapped or addressed. Examples of the association or link between each context-addressed tab and its associated selected element may include but is not necessarily limited to one of displaying a line between each context-addressed tab and its associated selected element, matching colors between each context-addressed tab and its associated selected element, varying transparency between each context-addressed tab and its associated selected element or any other arrangement for illustrating a link or association between each context-addressed tab and its associated selected element in the slide.

In block 206, the context-addressed tab associated with a chosen slide element may be highlighted or otherwise visually identified in response to a predetermined action with respect to the chosen slide element. For example, the context-addressed tab or tab label portion of the tab associated with a chosen slide element may be highlighted or identified in response to hovering over the chosen slide element with a computer pointing device similar to that known the computing arts. The context-addressed tab may then be activated by clicking-on the tab label portion, or optionally, the context-addressed tab may be automatically activated and the tab content portion may be presented in the computer window.

In block 208, a slide element associated with a chosen context-addressed tab may be highlighted or otherwise visually identified in response to a predetermined action with respect to the chosen context-addressed tab. For example, the slide element may be highlighted or identified in response to hovering over the chosen context-addressed tab or visible tab label portion or header of the tab with a computer pointing device.

In block 210, the context-addressed tab content may be presented in response to the context-addressed tab being selected. Similar to that previously described the context-addressed tab may be selected or activated by clicking-on the visible tab portion or header of the context-addressed tab with a computer pointing device or by activating the tab by some other means.

FIG. 3 is an example of a slide 300 in a presentation including context-addressed tabs 302a, 302b and 302c in accordance with an embodiment of the present invention. The slide 300 in FIG. 3 is being presented in a computer window 303. Each context-addressed tab 302a, 302b and 302c includes a tab portion, header or tab label portion 304a, 304b and 304c. Three tab label portions 304a, 304b and 304c are shown in the example illustrated in FIG. 3 for context-addressed tabs 302a, 302b and 302c. Each tab label portion 304a, 304b and 304c may include a label, for example, “LABEL TAB 1”, “LABEL TAB 2”, LABEL TAB 3″ as illustrated in FIG. 3. As previously described, the tab label may be entered by the user and may identify or in some way be related to the associated selected element to which the tab may be associated, linked, mapped or addressed.

Each context-addressed tab 304a, 304b and 304c may include a content area 306. Context-addressed tab 302a is the active tab or tab currently being displayed in the example of FIG. 3 and only the content area 306 for context-addressed tab 302a is being displayed and FIG. 3. As previously discussed, the content area 306 of the context-addressed tab 302a may include comments, notes or other information that may be related to the associated selected element in the currently displayed slide 300 of the presentation.

As previously described, an association or link between each context-addressed tab 302a, 302b, and 302c and its associated selected element 308a, 308b and 308c in the current slide 300 may be presented. Described another way, each context-addressed tab 302a, 302b and 302c may be mapped to its associated element 308a, 308b and 308c in the slide. The association or link may be selectively presented by operation of some feature in the slide 300 or window 303, such as a menu item, icon or other computer tool. The association or link may be toggled on and off by operation of the feature by a user. As illustrated in FIG. 3, the association or link may be represented or illustrated by a line 310a, 310b and 310c between each context-addressed tab 302a, 302b and 302c and its associated selected element 308a, 308b and 308c. Each line 310a, 310b and 310c may be the same or a different color or may be the same or different format, such as a broken line, chain line or other format. Other examples for presenting the association or link between each context-addressed tab 302a, 302b and 302c and its associated selected element 308a, 308b and 308c may include but is not necessarily limited to matching colors between each context-addressed tab and its associated selected element and varying a transparency between each context-addressed tab and its associated selected element.

Similar to that previously described, the selected element associated with a context-addressed tab may be highlighted or otherwise visually identified in response to a predetermined action relative the context-addressed tab, such as the context-addressed tab being selected or active or hovering a computer pointing device over the tab label portion. As illustrated in FIG. 3, Tab 1 302a has been selected and is active. The information in the content area of Tab 1 302a is displayed and the selected element 308a associated, linked, mapped or addressed to the context-addressed tab 302a may be highlighted or otherwise visually identified. In the example in FIG. 3, the associated element 308a is highlighted or identified by a rectangle or box 312 surrounding the element 308a. The box 312 may have a predetermined color or other visual feature to stand out from other features or elements in the slide 300. The box 312 may also flash to provide more visibility and draw the user's attention. While a box is illustrated in the example of FIG. 3 to identify the element 308a associated, linked or mapped to the active tab 302a, any mechanism for highlighting or identifying the associated element 308a in the current slide 300 may be used.

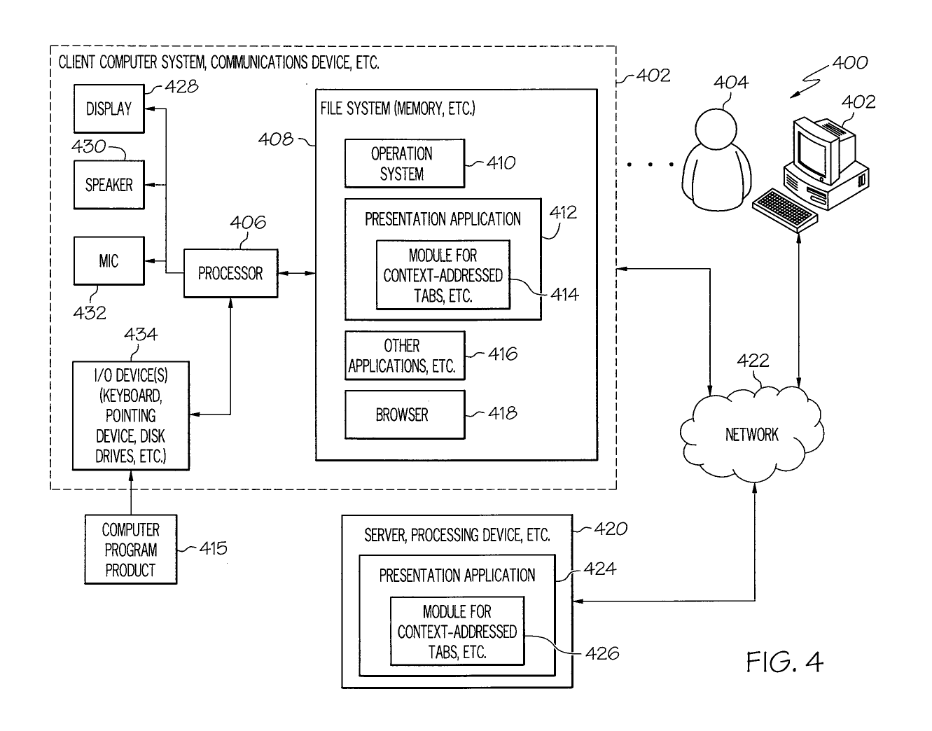

FIG. 4 is a block schematic diagram of an example of a system 400 for providing context-addressed tabs in a computer presentation application in accordance with an embodiment of the present invention. The methods 100 and 200 of FIGS. 1 and 2 may be embodied in or performed by the system 400. The system 400 may include a computer system 402 for use by a user 404 to prepare presentations and generate and use the context-addressed tabs similar to that described herein. The computer system 402 may be any type of computer device or communications device including a mobile device or the like capable of performing the functions or operations described herein.

The computer system 402 may include a processor 406 to control operation of the computer system 402 and a file system 408, memory or similar data storage device. An operating system 410 may be stored on the file system 408 for running or operating on the processor 406. A presentation application 412 may also be stored on the file system and may operate on the processor 406 for creating presentations similar to that described herein. A module for context-addressed tabs 414 may be associated with the presentation application 412 for generating and utilizing context-addressed tabs similar to that described herein. The module for context-addressed tabs 414 may be an integral part of the presentation application 412 similar to the exemplary system 400 illustrated in FIG. 4 or may be a separate module or application from the presentation application 412 that operates in coordination with the presentation application 412. The methods 100 and 200 may be embodied in the module for context-addressed tabs 414. The module for context-addressed tabs 414 may also be stored or embodied on computer readable storage medium or computer program product including a computer readable storage medium similar to that previously described, such as computer program product 415.

Other applications 416, software programs or the like may also be stored on the file system 408 for operation on the processor 406. A web or Internet browser 418 may also be stored on the file system 218 for accessing one or more resources, such as server 420 via a network 422. The network 422 may be the Internet, intranet or other network.

In accordance with an embodiment, the server 420 or processing device may include a presentation application 424. A module for context-addressed tabs 426 may also operate on the server 420 and may be an integral part of the presentation application 424 or may be a separate module or application. The presentation application 424 and context-addressed tabs module 426 on the server 420 may be provided in addition to the presentation application 412 and context-addressed tabs module 414 on the computer system 402. In another embodiment, only the presentation application 424 and context-addressed tabs module 426 on the server 420 may be provided, such as in a cloud computing environment or similar arrangement. The presentation application 424 and context-addressed tabs module 426 would then be accessed via the network 422 using the computer system or computing device 402.

The computer system 402 may also include a display 428 for presenting the presentation and slides contained in the presentation similar to the slide 300 illustrated in the window 304 in FIG. 3. The computer system 402 may also include a speaker system 430 for presenting any audio content that may be part of any presentation. The computer system 402 may additionally include a microphone 432 for the user 404 to aurally communicate via the computer system 402.

The computer system 402 may further include one or more input devices, output devices or combination input/output devices, collectively I/O devices 434. The I/O devices 434 may include a keyboard, pointing device, such as a mouse or other computer pointing device, disk drives and any other devices to permit a user, such as user 404, to interface with and control operation of the computer system 402 and network resources, such as server 420. The module for context-addressed tabs 414 may be loaded on the computer system 402 from a computer program product, such as computer program product 415 using one of the input devices 434.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

What is claimed is:

1. A method for providing and using context-addressed tabs in a computer presentation application, the method comprising:
selecting at least one element in a current slide of a presentation displayable in a computer window; and
generating a context-addressed tab in a predetermined area of the computer window for each selected element in the current slide of the presentation, each context-addressed tab being addressed to an associated selected element in the current slide of the presentation.

2. The method of claim 1, further comprising presenting a mechanism for entering a tab label in a tab label portion of each context-addressed tab.

3. The method of claim 1, further comprising allowing entry of content in a tab content area of each context-addressed tab.

4. The method of claim 1, further comprising presenting a feature to permit selective display of an association between each context-addressed tab and its associated selected element.

5. The method of claim 1, further comprising presenting an association between each context-addressed tab and its associated selected element.

6. The method of claim 5, wherein presenting the association between each context-addressed tab and its associated selected element comprises at least one of displaying a line between each context-addressed tab and its associated selected element, matching colors between each context-addressed tab and its associated selected element, and varying a transparency between each context-addressed tab and its associated selected element.

7. The method of claim 1, further comprising highlighting or otherwise identifying the context-addressed tab associated with a chosen element in the current slide in response to a predetermined action with respect to the chosen element.

8. The method of claim 7, wherein the predetermined action comprises hovering over the chosen element with a computer pointing device.

9. The method of claim 1, further comprising highlighting or otherwise identifying the associated selected element of a chosen context-addressed tab in response to a predetermined action with respect to the chosen context-addressed tab associated with the selected element.

10. The method of claim 1, further comprising presenting the context-addressed tab associated with each element as each slide of the presentation is displayed in the computer window.

11. The method of claim 1, further comprising presenting content of the content-addressed tab in response to a predetermined action with respect to a tab label portion.

12. A system for providing and using context-addressed tabs in a computer presentation application, the system comprising:
a processor;
a module, operating on the processor, for providing and using context-addressed tabs in a computer presentation application, the module comprising:
a module for selecting at least one element in a current slide of a presentation displayable in a computer window; and
a module for generating a context-addressed tab in a predetermined area of the computer window for each selected element in the current slide of the presentation, each context-addressed tab being addressed to an associated selected element in the current slide of the presentation.

13. The system of claim 12, further comprising a mechanism for entering a tab label in a tab label portion of each context-addressed tab and to allowing entry of content in a tab content area of each context-addressed tab.

14. The system of claim 12, further comprising a feature to permit selective display of an association between each context-addressed tab and its associated selected element.

15. The system of claim 14, wherein the association displayed between each context-addressed tab and its associated selected element comprises at least one of a line displayed between each context-addressed tab and its associated selected element, each context-addressed tab being a matched color with its associated selected element, each context-addressed tab and its associated selected element having a same transparency in the computer window.

16. The system of claim 12, further comprising:
a feature to highlight or otherwise identify the context-addressed tab associated with a chosen element in the current slide in response to a predetermined action with respect to the chosen element; and
a feature to highlight or otherwise identify the associated selected element of a chosen context-addressed tab in response to a predetermined action with respect to the chosen context-addressed tab associated with the selected element.

17. A computer program product for providing and using context-addressed tabs in a computer presentation application, the computer program product comprising:
a computer readable storage medium having computer readable program code embodied therewith, the computer readable program code comprising:
computer readable program code configured to select at least one element in a current slide of a presentation displayable in a computer window; and
computer readable program code configured to generate a context-addressed tab in a predetermined area of the computer window for each selected element in the current slide of the presentation, each context-addressed tab being addressed to an associated selected element in the current slide of the presentation.

18. The computer program product of claim 17, wherein the computer readable program code further comprises:
computer readable program code configured to present a mechanism for entering a tab label in a tab label portion of each context-addressed tab; and
computer readable program code configured to allow entry of content in a tab content area of each context-addressed tab.

19. The computer program product of claim 17, wherein the computer readable program code further comprises computer readable program code configured to selectively display an association between each context-addressed tab and its associated selected element.

20. The computer program product of claim 17, wherein the computer readable program code further comprises:
computer readable program code configured to highlight or otherwise identify the context-addressed tab associated with a chosen element in the current slide in response to a predetermined action with respect to the chosen element; and
computer readable program code configured to highlight or otherwise identify the associated selected element of a chosen context-addressed tab in response to a predetermined action with respect to the chosen context-addressed tab associated with the selected element.
